(19) United States
(12) Patent Application Publication
(10) Pub. No.: US 2025/0054045 A1
(43) Pub. Date: Feb. 13, 2025

(54) Artificial Intelligence Generated Business Profiles

(71) Applicant: Google LLC, Mountain View, CA (US)

(72) Inventors: Timothy Benjamin Whalin, Seattle, WA (US); Hanny Kamal, Seattle, WA (US)

(21) Appl. No.: 18/540,282

(22) Filed: Dec. 14, 2023

Related U.S. Application Data
(60) Provisional application No. 63/531,903, filed on Aug. 10, 2023.

(51) Int. Cl. G06Q 30/0601; G06F 40/40; G06Q 30/0201

(52) U.S. Cl. CPC G06Q 30/0631; G06F 40/40; G06Q 30/0201; G06Q 30/0641

(57) ABSTRACT

The technology is generally directed to generating curated profiles for businesses. A curated profile may provide curated information to a user about a respective business. Generating the curated profile may include receiving a user query corresponding to a business and data related to the business and data related to a user associated with the user query, such as a user that submitted the query. A curated profile corresponding to the business may be generated based on the data related to the business and the data related to the user associated with the query.

### CROSS-REFERENCE TO RELATED APPLICATION

This application claims the benefit of the filing date of U.S. Provisional Patent Application No. 63/531,903, filed Aug. 10, 2023, the disclosure of which is hereby incorporated herein by reference.

### BACKGROUND

Many businesses create profiles that provide an overview of the business. These business profiles generally include information about the business such as an overview of the goods or services provided by the business, the location of the business, the hours of the business, contact information, a website link, and other such information. These business profiles are provided to users in applications such as mapping programs, search engines, or other such applications when a user submits a user query for the business or something related to the business. However, these business profiles typically follow a static template and provide the same information to each user who views the profile. As each user's interests and needs are different, a generic business profile may not provide relevant information to each user.

### BRIEF SUMMARY

The technology is generally directed to generating curated business profiles for a user in response to a user-submitted query and, in some instances, based on the user's prior activity. The curated profiles may be generated by a machine learning (ML) model, such as a large language model (LLM), based on information about the business and the user. Each curated profile may be unique to the user to which the curated profile is being provided and may include curated information about the business that is likely relevant to the user. Such curated information may include content such as articles, social media posts, products, and services from the business, as well as other information typically included in business profiles, such as the location of the business, the hours of the business, contact information for the business, and a link to the business's website.

The curated information provided in the curated profile may be provided based on context data associated with the user, such as user preferences and the user query submitted by the user. Moreover, the curated profile may be dynamic, such that a user can “zoom in and out” to find the information they want. In some instances, the curated profile may include a “chat with a business” feature through which a user can interact with the business. Such interactions may include asking questions regarding products and/or services offered by the business, or any other information related to the business. As such, the curated profile may provide information related to the business in real-time to a user.

In some implementations, the techniques disclosed herein enable artificial intelligence to generate curated profiles. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

One aspect of the disclosure is directed to a method for generating curated content comprising: receiving, by one or more processors, a user query corresponding to a business; receiving, by the one or more processors, data related to the business and data related to a user associated with the user query; and generating, by the one or more processors, a curated profile corresponding to the business based on the data related to the business and the data related to the user associated with the query.

Another aspect of the disclosure is directed to a system comprising one or more computing devices. The one or more computing devices may be configured to: receive a user query corresponding to a business; receive data related to the business and data related to a user associated with the user query; and generate a curated profile corresponding to the business based on the data related to the business and the data related to the user associated with the query.

In some instances, the user query is received from a service application comprising any one or more of a search engine, mapping application, email application, social application, video application or website, or app store.

In some instances, the data related to the business includes one or more of data from a website, social media, or advertisement associated with the business.

In some instances, the data related to the user includes one or more of demographics, location, or browsing history associated with the user.

In some instances, the curated profile includes information related to the business, the information related to the business including one or more of a logo of the business, a link to a website of the business, or a link to a social media account of the business.

In some instances, generating the curated profile includes generating, by a machine learning model, a business description, the business description providing an overview description of the business.

In some instances, generating the curated profile includes generating, by a machine learning model, personalized tabs, the personalized tabs corresponding to categories of information about the business, wherein the personalized tabs are identified as being of interest to the user. In some examples, each of the personalized tabs includes respective curated content relevant to the user query and the user data.

In some instances, the curated profile further includes personalized content, wherein the personalized content include one or more of links to web content, images, or multimedia that is curated according to the user query and/or user preferences. In some examples, the personalized content is further generated based on information related to the business.

In some instances, the curated profile is generated in response to a request received from a service application.

### BRIEF DESCRIPTION OF THE DRAWINGS

FIG. 1A is an illustration of an example curated profile for a business according to aspects of the disclosure.

FIG. 1B is an illustration of an example curated profile for more than one business according to aspects of the disclosure.

FIG. 1C is an illustration of another example curated profile for more than one business according to aspects of the disclosure.

FIG. 2 is an illustration of an example personalized tab within a curated profile according to aspects of the disclosure.

FIG. 3 is an illustration of an example chat interface within a curated profile according to aspects of the disclosure.

FIG. 4 is an illustration of an example service application in accordance with aspects of the disclosure.

FIG. 5 is a diagram of an example implementation of a curated profile ML model for generating curated profiles for a service application, according to aspects of the disclosure.

FIG. 6 is a block diagram of an example computing platform on which curated profile ML model can be implemented, in accordance with aspects of the disclosure.

FIG. 7 is a block diagram of an example environment for implementing a curated profile ML model, in accordance with aspects of the disclosure.

FIG. 8 is a block diagram of an example environment for implementing ML models within a datacenter, according to aspects of the disclosure.

FIG. 9 is a flow diagram illustrating an example process for generating a curated profile, in accordance with aspects of the disclosure.

### DETAILED DESCRIPTION

The technology is generally directed to generating curated profiles for businesses. A curated profile may provide curated information to a user about a respective business. The curated information within a curated profile may be determined to likely be of interest to the user for which the curated profile is generated. The curated profiles may be generated by a machine learning (ML) model, such as a large language model (LLM), based on information about the business and the user. In this regard, each curated profile may provide information corresponding to a business that is curated according to a particular user's query and/or preferences such that the provided information is likely relevant to the user. In some instances, the format and/or content of the curated profile may be based on information derived from a brand's website and/or based on commonalities across different brand websites. Curated profiles, therefore, provide dynamic and personalized information about a business to a user. Thus, users are provided with relevant information about a business without the need to conduct searches for the information, call the business, or scour a business' website or other websites for the relevant information.

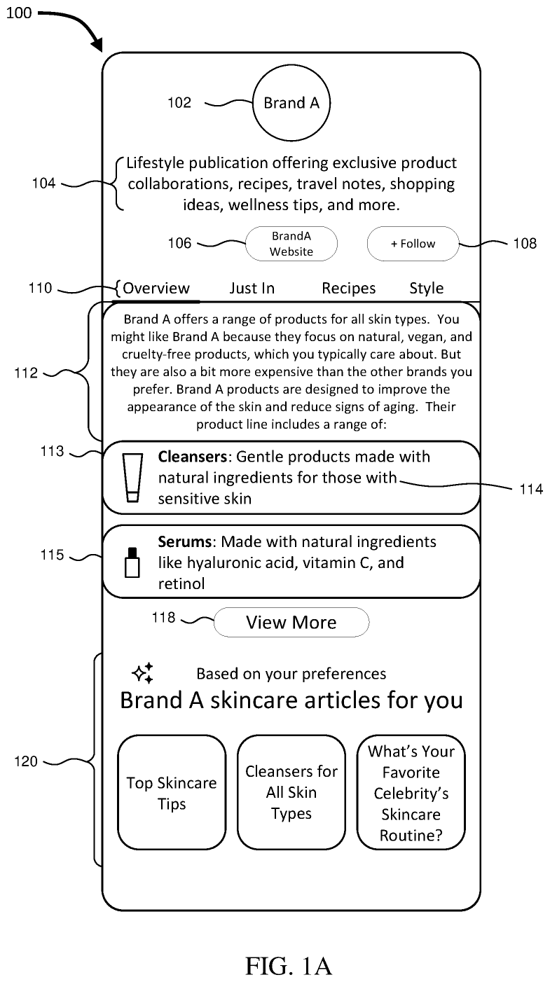

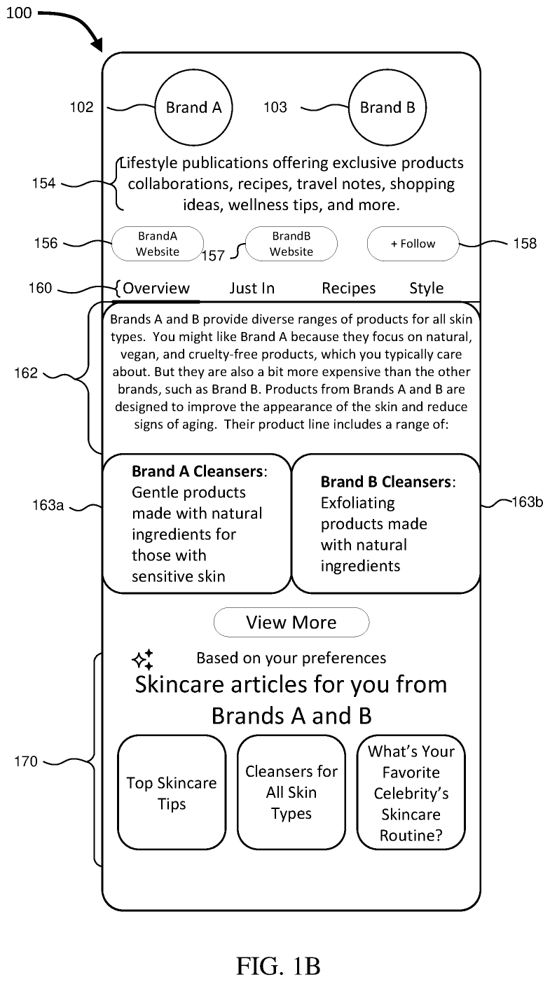

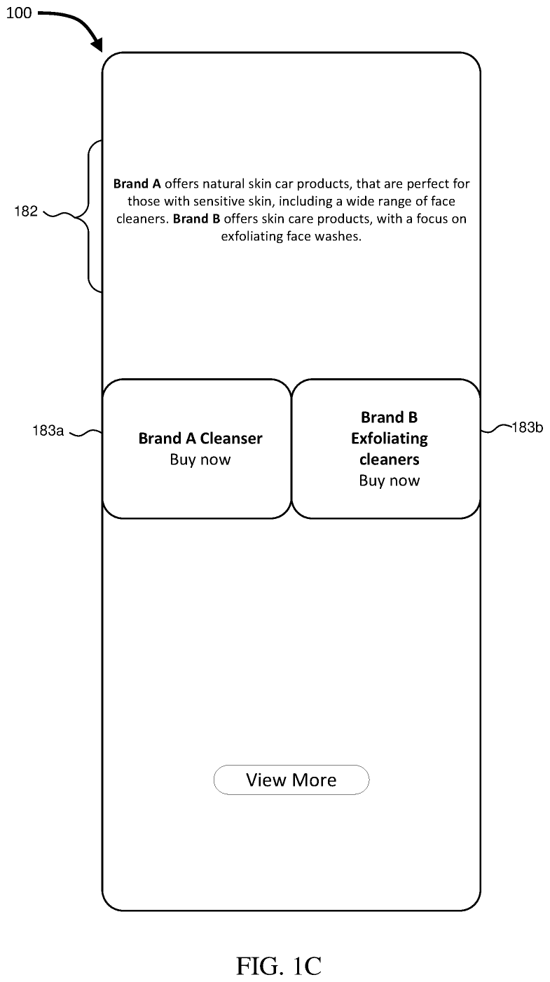

FIG. 1A illustrates an example curated profile 100 for business Brand A, generated in response to a query for a “skincare routine” submitted by a user to a service application. As shown, curated profile 100 includes a business description 104, personalized tabs 110, and personalized content 120 corresponding to Brand A. Curated profile 100 also includes general information typically included in business profiles, such as logo 102, a link to the business's website 106, a link to follow the business 108, such as within the service application or on social media. In some instances, the link to follow the business 108 may direct the user to a social media account of the business or a webpage containing links to the social media accounts of the business.

A business description, such as business description 104, may provide a general overview of the business for which the curated profile is generated. For instance, and with reference to FIG. 1, business description 104 includes a general description of Brand A. Business descriptions may be provided to the ML model and/or generated by the ML model. In this regard, the ML model may incorporate a business description that it is provided, such as from an employee or other individual associated with the business or service application (or any other individual or service), into the curated profile. Alternatively, or additionally, the business description may be generated by the ML model based on data corresponding to the business.

Personalized tabs, such as personalized tabs 110, may correspond to categories of information about the business for which the curated profile is generated. Personalized tabs within a curated profile may be generated based on a determination of categories a user is likely to find of interest. For instance, and as further illustrated in FIG. 1A, the personalized tabs 110 of curated profile 100 correspond to categories including “Overview”, “Just In”, “Recipes”, and “Style.” The categories of each of these personalized tabs may be determined to be of interest to the user for whom the curated profile was generated. For curated profile 100, the user for whom the curated profile was generated is the user that submitted the search query for a “skincare routine.”

The content of each personalized tab may also be curated for each user. For instance, and as further shown in FIG. 1A, within the “Overview” personalized tab of the curated profile is curated content including a customized description of Brand A 112, and types of products offered by Brand A including cleansers 113 and serums 115 that focus on natural skincare, which may be determined to be of interest to the user. In some instances, the content may be linked to the business' website. For instance, cleansers 113 content may include a link to an online store for Brand A with a listing of cleansers. The curated content provided within each personalized tab may be generated by an ML model. For instance, and referring to cleansers 113, the ML model may pull an example image of a cleanser from Brand A's website and generate a general description of cleansers 114 offered by Brand A. In some instances, the ability to view more (or less) content may be provided within a personalized tab, such as via a button or scrolling within the personalized tab. For instance, and with reference to FIG. 1A, the view more button 118, when selected, may populate additional content (e.g., hand soap, moisturizers, etc.) within the personalized tab and/or direct a user to Brand A's website, where additional skincare products may be found.

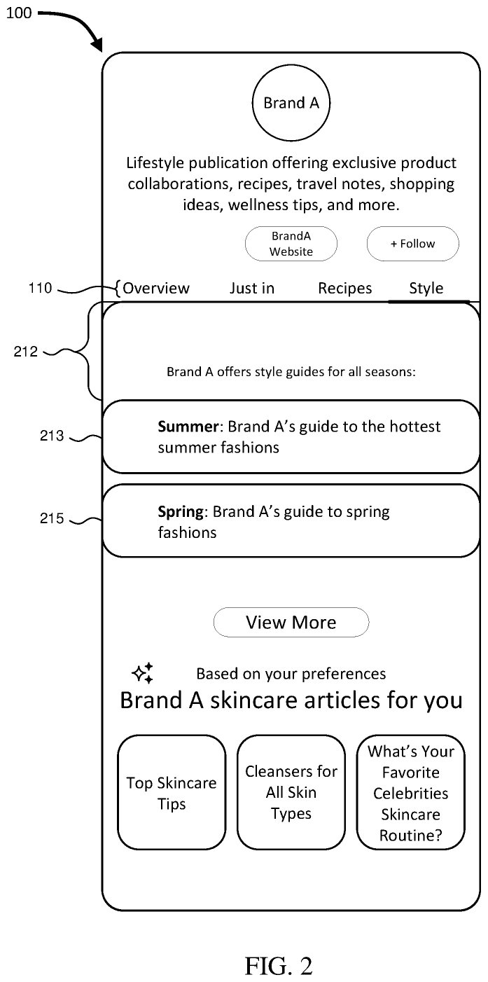

A user may be able to navigate to each personalized tab in a curated profile, such as by selecting, scrolling, swiping, etc., to an intended personalized tab. Content corresponding to the intended personalized tab may be shown after selecting or otherwise navigating to the intended personalized tab. For instance, a user may navigate from the “Overview” personalized tab to the “Style” personalized tab by selecting the “Style” personalized tab. Upon selecting or otherwise navigating to the “Style” personalized tab, as illustrated by the bold underline under the “Style” category within the personalized tabs 110 of FIG. 2, the content displayed within the curated profile 100 may change from content associated with the “Overview” personalized tab to the “Style” personalized tab. In this example, the content included in the “Overview” personalized tab, including the customized description of Brand A 112, cleansers 113, and serums 115 are replaced with a customized description of Brand A's style guides 212 and style guides 213, 215.

Although FIG. 1A illustrates curated profile 100 as having four personalized tabs, including an “Overview” tab, a “Just In” tab, a “Recipes” tab, and a “Style” tab, related to Brand A and services and/or products offered by Brand A, a curated profile generated for another user and/or business may include any number of personalized tabs corresponding to any number of categories. For instance, a curated profile for a restaurant may include personalized tabs corresponding to the restaurant's offerings and/or user's preferences, such as a personalized tab directed to an overview of the restaurant, a personalized tab directed to a food menu focusing on fish, which the user preferences indicate the user favors, and a personalized tab directed to a drink menu. In some instances, curated profiles may take into account patterns and commonalities between users and their respective preferences and user data to determine content for the curated profile. For example, users searching for a credit card who are known to look for deals may be provided a listing of credit cards for “cash back seekers,” instead of “for travel.”

As further described herein, each of the personalized tabs 110 and the content provided within each tab may be generated by the ML model based on information related to the business and/or the user, a user's preferences, the submitted user query, and other contextual information.

Personalized content 120, as shown in FIG. 1A, includes links to articles published by Brand A. However, personalized content may include any of the following, including links to web content, images, videos, etc., that is curated according to a particular user query and/or user preferences such that the provided information is likely relevant to the particular user. The personalized content provided within a curated profile may be generated and/or otherwise provided by the ML model based on information related to the business and/or the user, a user's preferences, the user query submitted, and/or other contextual information as further described herein.

Curated profile 100 is merely an example curated profile. Other curated profiles may include more or less information about respective businesses or other content typically included in business profiles. For instance, a curated profile may include a business' hours of operation. In another example, a curated profile may not include personalized content and/or personalized tabs.

In some instances, curated profiles may be generated for more than one business. For instance, FIG. 1B illustrates an example curated profile 140 for businesses Brand X and Brand B, generated in response to a query for a “skincare routine” submitted by a user to a service application. As shown, curated profile 140 includes a business description 154, personalized tabs 160, and personalized content 170 corresponding to Brands X and B. Like curated profile 100, curated profile 140 may also include general information typically included in business profiles, such as logos 142, 143, a link to the business' websites 156, 157, a link to follow one or both of the business 158, such as within the service application or on social media. In some instances, the link to follow the businesses 158 may direct the user to a social media accounts of the businesses or webpages containing links to the social media accounts of the businesses. Although FIG. 1B illustrates a single follow link 158, a curated profile may include any number of follow links, such as follow links for each business in the curated profile. Moreover, although FIG. 1B illustrates only two businesses, Brand B and Brand X, a curated profile may include any number of brands.

As further illustrated in FIG. 1B, the business description 154 may be generated to account for each brand of the curated profile. Alternatively, or additionally, separate business descriptions may be provided for each business in the curated profile. Like curated profile 100, curated profile 140 may include personalized tabs, such as personalized tabs 160, which may correspond to categories of information about the businesses for which the curated profile is generated.

The content of each personalized tab may also be curated for each user. For instance, and as further shown in FIG. 1B, within the “Overview” personalized tab of the curated profile 140 is curated content including a customized description of Brands B and X 162, and types of products offered by Brand X (cleansers 163a) and Brand B (cleansers163b). The curated content provided within each personalized tab may be generated by an ML model. For instance, and referring to Brand X's cleansers 163a, the ML model may pull or generate a general description of cleansers offered by Brand X. Similarly, and referring to Brand B's cleansers 163b, the ML model may pull or generate a general description of cleansers offered by Brand B.

Personalized content 170, as shown in FIG. 1B, includes links to articles published by Brands X and B. However, personalized content may include any of the following, including links to web content, images, videos, etc., that is curated according to a particular user query and/or user preferences such that the provided information is likely relevant to the particular user. The personalized content provided within a curated profile may be generated and/or otherwise provided by the ML model based on information related to the business and/or the user, a user's preferences, the user query submitted, and other contextual information such as user location, user device type, user device settings (e.g. type scale could change how much text can be included in a profile), dark mode vs light mode, etc., and other such information.

In some instances, curated profiles corresponding to different brands may be aggregated together around a given topic or interest of the user. For example, if the search history of the user indicates the user previously searched for “skincare routine,” the ML model may determine the user may have interest in a sub-topic, such as “moisturizing dry skin.” The ML model may compile and output a variety of “curated profiles” corresponding to the sub-topic, such as curated profiles related to multiple brands and/or products that are related to the given sub-topic. Another example curated profile is illustrated in FIG. 1C. The curated profile illustrated in FIG. 1C may be generated in response to a search for “face care.” The ML Model may determine that the likely interest of the user in submitting the “face care” query is for “face cleansers.” This determination may be based on search history, purchase history, etc., of the user. In response, the curated profile may highlight multiple brands and brand products that match the likely interest of the user. In this regard, and as illustrated in FIG. 1C, the curated profile includes a customized description of Brands A and B 182 (including links to a website associated with Brands A and B or products of Brands A and B, illustrated by the bold text), and products offered by Brand A (cleanser 183a) and Brand B (cleanser 183b), which may include links to buy the products.

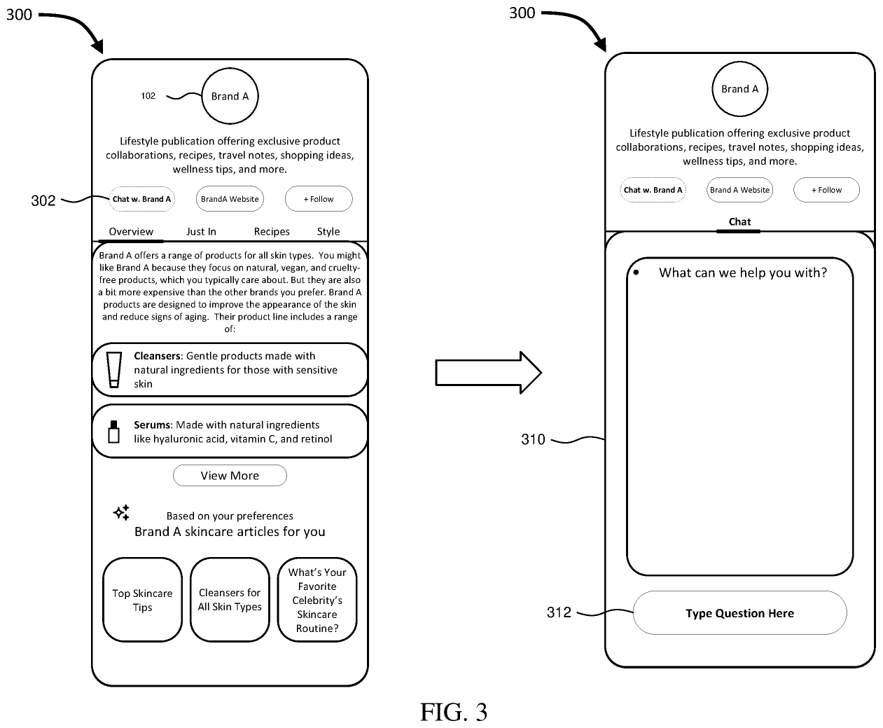

A curated profile may also include options for interacting with a business. For instance, as shown in FIG. 3, curated profile 300, which may be compared to curated profile 100, includes a chat button 302. Upon selecting the chat button 302, the curated profile may display a chat interface 310. A user may type questions or other such communication into the chat via a text input box 312. Questions and other communication submitted through the chat interface 310 may be sent to the business associated with the curated profile 300. The business may respond to the questions and other such communication, and the business' responses may be presented in the chat interface 310.

A curated profile, such as curated profile 100, may be provided in response to a service application receiving a user query, such as an image or text search query or a user selection of content submitted to the service application. The service application may include any application that provides information to a user of the service application in response to a user query (e.g., user selection, text or image search, etc.), such as a search engine, mapping application, email application, social application, video application or website, app store, or any other such application that provides information corresponding to a business, such as services or products offered by a business, to a user. For example, a third-party website may provide a listing of businesses or a digital component related to a business. Upon a user selecting a business listing or a digital component (e.g., banner, thumbnail image, etc.), the third-party website may provide a curated profile or direct the user to a curated profile at another site or application, such as provided by a service application.

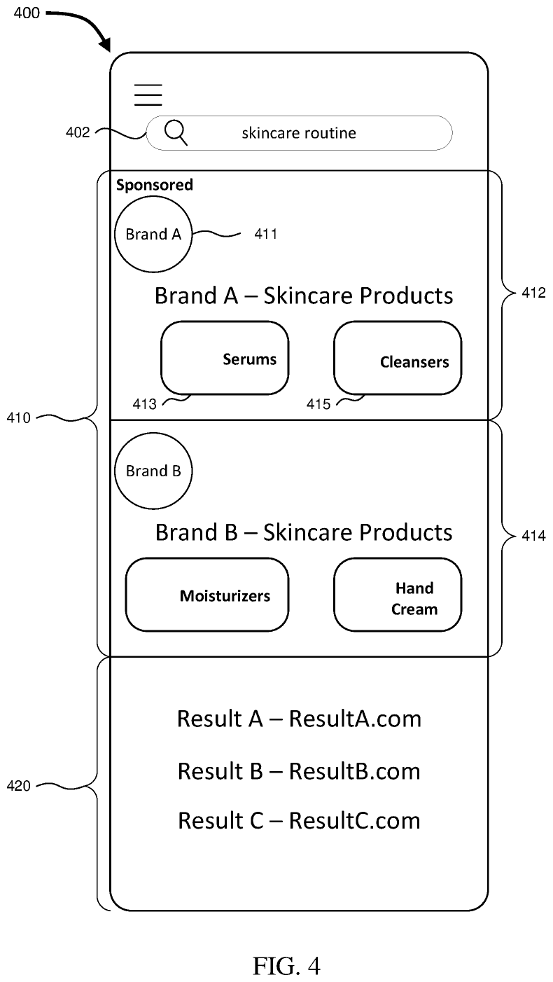

FIG. 4 illustrates an example service application 400, a search engine. The service application 400 includes a search bar 402 through which a user may submit a query. As further illustrated in FIG. 4, a user query for “skincare routine” has been entered into the search bar 402 and submitted to the service application 400. Although FIG. 4 illustrates the user submitting a user query through search bar 202, a service application can include, additionally or alternatively, other options for a user to submit a query, such as through speech inputs or via a selection of suggested queries provided within the service application. For example, a service application may provide a listing of suggested queries from which a selection can be made.

In response to the user query, the service application 400 provides search results, including sponsored search results 410 and general search results 420. Sponsored search results may include search results corresponding to businesses that have an agreement, partnership, or other such relationship with the service application. For instance, as shown in FIG. 4, sponsored search results include Brand A 412 and Brand B 414. General search results may include all other results illustrated as results A, B, and C in FIG. 4. Although FIG. 3 illustrates general and sponsored search results, search results may not be separated and/or search results may be separated into different groupings than general and sponsored.

A curated profile corresponding to one of the search results, such as Brand A 412 or Brand B 414, may be provided in response to a selection of one of the search results. In this regard, upon a user selecting a search result or a particular portion of a search result, a curated profile for the business corresponding to the search result may be provided. For example, a user may select the search result for Brand A 412 by selecting icon 411 or links 413, 415. Upon receiving this selection, the service application 400 may provide a curated profile corresponding to the selected business. The curated profile may be generated by an ML model, as described further herein. Although the preceding example describes a curated profile being provided for a sponsored search result for Brand A 412, a curated profile may be provided for any search result, including general search results.

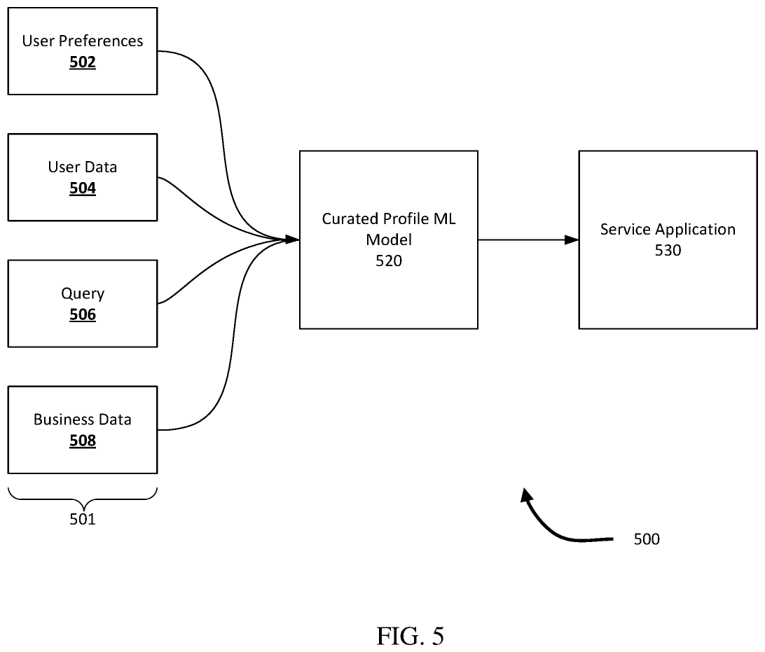

FIG. 5 is a diagram showing an example implementation 500 of a curated profile ML model 520 for generating curated profiles for a service application 530. The curated profile ML model 520 may receive data 501 corresponding to businesses and users of a service application, such as service application 530. The data 501 may include user preferences 502, user data 504, a user query 506, and business data 508. User preferences 502 may include data indicating the preferences of a user using a service application, such as service application 530. User data 504 may include data corresponding to a user using a service application, such as service application 530. For instance, user data may include user demographics, user location, browsing history, saved results, shared history, settings, etc. Query 506 may be a query submitted by the user, such as user query 402. Business data 508 may include information related to the business for which the curated profile is being generated, including data from the business' website, social media, advertisements, user-generated content, customer reviews, etc.

Further to the descriptions herein, a user may be provided with controls allowing the user to make an election as to both if and when systems, programs, or features described herein may enable the collection of user information (e.g., user demographics, browsing history, user preferences, etc.), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level) so that a particular location of a user cannot be determined. Thus, the user may have control over what information is collected about the user, how that information is used, and what information is provided to the user.

The curated profile ML model 520 may use the data 501 to generate curated profiles, such as curated profile 100. The generated curated profile may be provided to the service application 530 for output on an output device, such as a display, on a user device, such as user computing device 628, described further herein.

The curated profile ML model 520 may include any generative ML models, including but not limited to natural language processing models (NLPs), language models (LMs), large language models (LLMs), or other such model capable of generating text and/or outputting images or other such multimedia, such as text-to-image diffusion models and Generative Adversarial Networks (GANs). In this regard, the curated profile ML model 520 may be any of a variety of different machine learning or statistical models, such as deep neural networks, recurrent neural networks, transformers, etc. The curated profile ML model 520 may be trained to receive data associated with a request for a curated profile, such as data 501. The curated profile ML model 520 may be initially trained and then fine-tuned or retrained with input from users. Any of a variety of different machine learning or statistical models that can be trained as described herein may be used, not limited to NLP models, LM, or LLM models. While examples described herein may refer to specific model types, such examples should not be considered limited to those model types. For instance, examples describing the training or use of an LM may be equally applicable to NLPs, LLMs, and other such ML models.

The curated profile ML model 520 can be trained on relatively smaller datasets relative to other models that generate natural language, imagery and/or other such multimedia as output. As described herein, data corresponding to the service application for which curated profiles are generated may be used to generate many different training examples consistent with real-world usage, as opposed to approaches for training generative ML models to output natural language, imagery, and other such multimedia, which requires large amounts of training data from many sources, such as more general generative ML models.

The curated profile ML model 520 can be trained for handling curated profile generation for different types of service applications, such as search engines, mapping applications, and other such applications that provide information corresponding to a business, such as services or products offered by a business, to a user. Although the curated profile ML model 520 is shown as being a stand-alone component in FIG. 5, the curated profile ML model 520 may be a plug-in configured to integrate into the service application 530, integrated directly into the service application 530, etc.

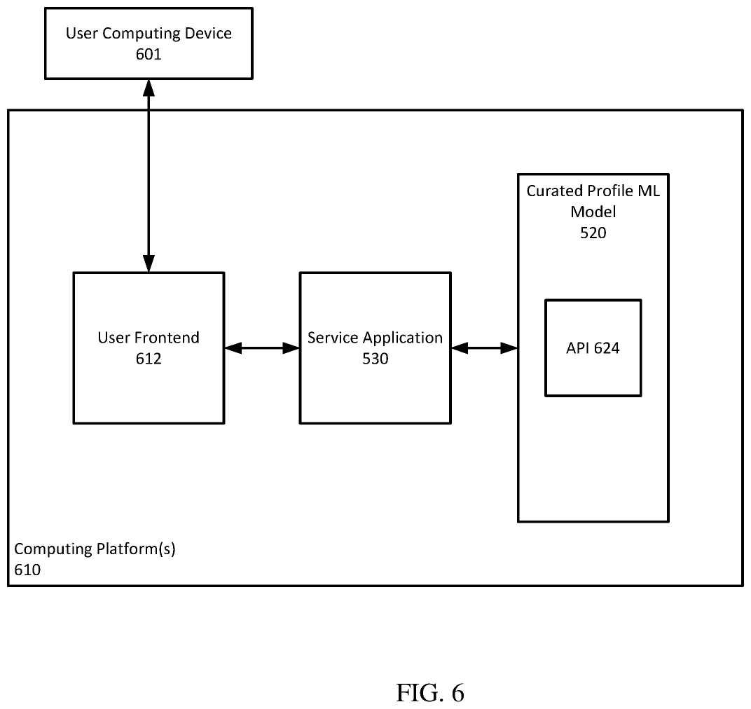

FIG. 6 is a block diagram of computing platform(s) 610 on which the curated profile ML model 520 can be implemented. As shown, the computing platform 610 includes a user frontend 612, which may be the interface through which the user interacts with the service application 530. For instance, the user computing device may submit a query, such as query 506 to the service application 530 through the user frontend 612. The user computing device 601 may also receive data, such as a curated profile from the service application 530 through the user frontend 612. In some instances, a user computing device 601 may communicate directly with the service application 530, bypassing any user front end. The curated profile ML model 520 may include an Application Program Interface (API) 124 through which the service application 530 and/or other applications can interact with the curated profile ML model 520.

The computing platform 610 may be implemented on one or more computing devices, such as one or more servers. For instance, the user frontend 612 may be implemented on a first server, the service application 530 may be executed on a second, different server, and the curated profile ML model 520 may be executed by the first server, the second, or a third, different server. Additionally, or alternatively, each of the user frontend 612, service application 530, and curated profile ML model 520 may be implemented on the same or different servers.

User computing device 601 may be any of a variety of devices configured to communicate with the computing platform 610, for example over a network. Example user computing devices include a personal laptop, a personal mobile device or other handheld device, a wearable device, such as a helmet, glasses, a smartwatch, earbuds, etc., or a game console. Although user computing device 601 is shown separately from the computing platform 610, in some examples, portions of the computing platform 610 can be executed on the user computing device 601. For instance, the user computing device may execute the user frontend 612, service application 530, and/or curated profile ML model 520.

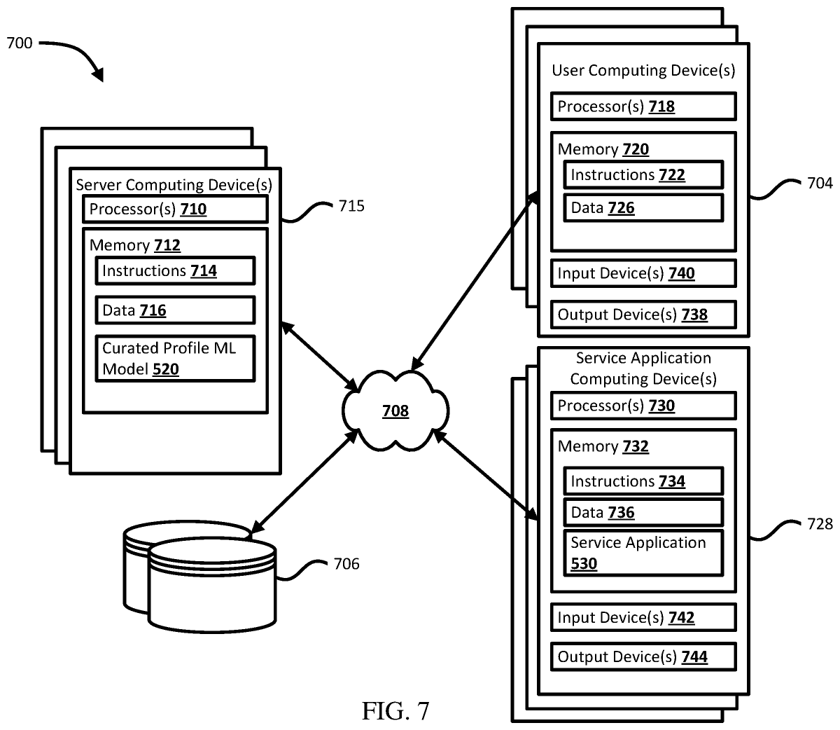

FIG. 7 depicts a block diagram of an example environment 700 for implementing a curated profile ML model, such as curated profile ML model 520. The system 700 can be implemented on one or more devices having one or more processors in one or more locations, such as in server computing device(s) 715. User computing device(s) 704, service application computing device(s) 728, and server computing device(s) 715 (referred to collectively herein, as “computing devices”) can be communicatively coupled to one or more storage devices 706 over a network 708. The storage devices 706 can be a combination of volatile and non-volatile memory and can be at the same or different physical locations than the computing devices 715, 704, 728. For example, the storage devices 706 can include any type of non-transitory computer-readable medium capable of storing information, such as a hard drive, solid state drive, tape drive, optical storage, memory card, ROM, RAM, DVD, CD-ROM, write-capable, and read-only memories.

Server computing device 715 can include one or more processors 710 and memory 712. The memory 712 can store information accessible by the processors 710, including instructions 714 that can be executed by the processors 710. The memory 712 can also include data 716 that can be retrieved, manipulated, or stored by the processors 710. The memory 712 can be a type of non-transitory computer readable medium capable of storing information accessible by the processors 710, such as volatile and non-volatile memory. The processors 710 can include one or more central processing units (CPUs), graphic processing units (GPUs), field-programmable gate arrays (FPGAs), and/or application-specific integrated circuits (ASICs), such as tensor processing units (TPUs).

The instructions 714 can include one or more instructions that, when executed by the processors 710, cause the one or more processors to perform actions defined by the instructions 714. The instructions 714 can be stored in object code format for direct processing by the processors 710, or in other formats including interpretable scripts or collections of independent source code modules that are interpreted on demand or compiled in advance. The instructions 714 can include instructions for implementing an curated profile ML model, such as curated profile ML model 520. The curated profile ML model 520 can be executed using the processors 710, and/or using other processors remotely located from the server computing device 715.

The data 716 can be retrieved, stored, or modified by the processors 710 in accordance with the instructions 714. The data 716 can be stored in computer registers, in a relational or non-relational database as a table having a plurality of different fields and records, or as JSON, YAML, proto, or XML documents. The data 716 can also be formatted in a computer-readable format such as, but not limited to, binary values, ASCII, or Unicode. Moreover, the data 716 can include information sufficient to identify relevant information, such as numbers, descriptive text, proprietary codes, pointers, references to data stored in other memories, including other network locations, or information that is used by a function to calculate relevant data.

The user computing device 704 and service application computing device 728 can be configured similarly to the server computing device 715, with one or more processors 718, 730, memory 720, 732, instructions 722, 734 (such as the service application 530, which may additionally or alternatively, be executed by the server computing device 715), and data 726, 736, respectively. The user computing device 704 and service application computing device 728 can also include a user input 740, 742 and a user output 738, 744, respectively. The user input 740, 742 can include any appropriate mechanism or technique for receiving input from a user, such as a keyboard, mouse, mechanical actuators, soft actuators, touchscreens, microphones, and sensors.

The server computing device 715 and/or service application computing device 728 can be configured to transmit data to the user computing device 704, and the user computing device 704 can be configured to display at least a portion of the received data on a display implemented as part of the user output 738. For instance, the user output 738 can be used for displaying the service application 530 received from the service application computing device 728 and/or a curated profile received from the service computing device 715. In some instances, the curated profile generated by the server computing device may be provided by the server computing device 715 to the service application computing device 728, which may transmit the curated profile to the user computing device 704. In other instances, the curated profile ML model 520 may be executed on the service application computing device 728. In this example, the service application computing device may generate the curated profile, which it may subsequently share with the user computing device. In another example, the server computing device 715 may execute the service application 530. In this example, the server computing device may provide both the curated profile and the service application 530 to the user computing device 704. The user output 738 can alternatively or additionally include one or more speakers, transducers or other audio outputs, a haptic interface or other tactile feedback that provides non-visual and non-audible information to the user of the user computing device 704.

Although FIG. 7 illustrates the processors 710, 718, 730 and the memories 712, 720, 734 as being within the computing devices 715, 704, and 728, components described herein can include multiple processors and memories that can operate in different physical locations and not within the same computing device. For example, some of the instructions 714, 344 and the data 716, 736 can be stored on a removable SD card and others within a read-only computer chip. Some or all of the instructions and data can be stored in a location physically remote from, yet still accessible by, the processors 710, 730. Similarly, the processors 710, 730, 718 can include a collection of processors that can perform concurrent and/or sequential operation. The computing devices 704, 715, 728 can each include one or more internal clocks providing timing information, which can be used for time measurement for operations and programs run by the computing devices 704, 715, 728.

The server computing device 715 and/or service application computing device 728 can be connected over the network 708 to a datacenter (not shown) housing any number of hardware accelerators. The datacenter can be one of multiple datacenters or other facilities in which various types of computing devices, such as hardware accelerators, are located. Computing resources housed in the datacenter can be specified for deploying curated profile ML models, such as curated profile ML model 520, or a service application, such as service application 530, as described herein. In some instances, the server computing device 715 and/or service application computing device 728 can be part of the datacenter.

The service application 530 of the service application computing device 728 may be configured to receive a query, such as query 402, from a user computing device. The service application 530 may provide data, such as data 501 to the curate profile ML model 520 of the server computing device in response to receiving the query or in response to another request associated with the query, such as the user requesting profile information by selecting a link or other such icon. Server computing device 715 may use the data 501 to generate a curated profile using the curated profile ML model 520. In this regard, server computing device 715 may execute the curated profile ML model 520 internally or with the assistance of a datacenter, such as datacenter 804 (described herein). Alternatively, the service application 530 may be executed by the server computing device 715 and/or the curated profile ML model may be executed by the service application computing device 728. In some instances, the server computing device and/or service application computing device 728 may retrieve additional data, such as additional data related to the business or user for use in generating curated profiles.

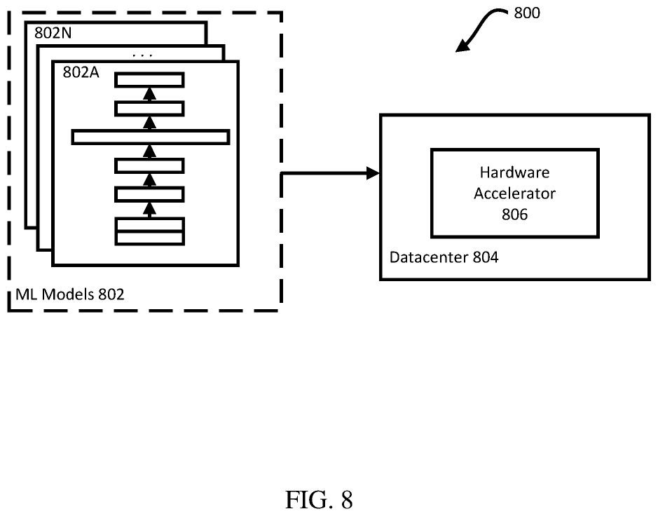

FIG. 8 depicts a block diagram 800 illustrating one or more ML model architectures 802, more specifically 802A-N for each architecture, for deployment in a datacenter 804 housing a hardware accelerator 806 on which the deployed ML models 802 will execute, such as for providing curated profiles, such as curated profile 100. The hardware accelerator 806 can be any type of processor, such as a CPU, GPU, FPGA, or ASIC such as a TPU.

An architecture 802 of a ML model can refer to characteristics defining the ML models, such as characteristics of layers for the ML models, the nature of input to the layers, how the layers process the input, and/or how the layers interact with one another. The architecture 802 of the ML models can also define types of operations performed within each layer. One or more ML model architectures 802 can be generated that can output results, such as for generating curated profiles.

Referring back to FIG. 7, the computing devices 715, 704, 728 and the datacenter 804 (shown in FIG. 8) can be capable of direct and indirect communication over the network 708. For example, using a network socket, the user computing device 704 can connect to a service, such as a service application, operating in the datacenter through an Internet protocol. The computing devices 715, 704, 728 can set up listening sockets that may accept an initiating connection for sending and receiving information. The network 708 itself can include various configurations and protocols including the Internet, World Wide Web, intranets, virtual private networks, wide area networks, local networks, and private networks using communication protocols proprietary to one or more companies. The network 708 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 708, in addition or alternatively, can also support wired connections between the computing devices 715, 704, 728 and the datacenter 804, including over various types of Ethernet connection.

Although components of a server computing device 715, user computing device 704, and service application computing device 728 are shown in FIG. 7, other server computing devices, user computing devices, and service application computing devices may have similar components. Aspects of the disclosure described herein can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing ML models, and any combination thereof.

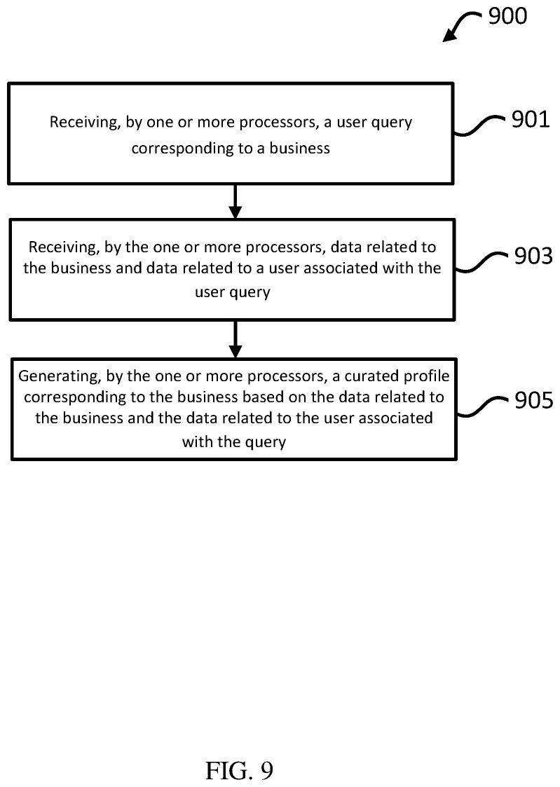

FIG. 9 illustrates an example method for generating a curated profile. The following operations do not have to be performed in the precise order described below. Rather, various operations can be handled in a different order or simultaneously, and operations may be added or omitted.

In block 901, a user query corresponding to a business may be received. The submission may be received by, in some examples, a service application which may provide the user query to one or more processors implementing a curated profile ML model. In some instances, the service application may provide the user query to the one or more processors after the user requests a curated profile through the service application. Alternatively, or additionally, the service application may provide the user query upon receiving the user query.

In block 903, data related to the business and data related to the user associated with the user query may be received. The data related to the business may be retrieved by the one or more processors and/or provided to the one or more processors, such as from the service application. The data related to the user associated with the user query may be retrieved by the one or more processors and/or provided to the one or more processors, such as from the service application.

In block 905, a curated profile corresponding to the business may be generated. The curated profile may be generated based on the data related to the business and the data related to the user associated with the user query.

In this disclosure, the phrase “configured to” is used in different contexts related to computer systems, hardware, or part of a computer program, engine, or module. When a system is said to be configured to perform one or more operations, the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

While operations shown in the drawings, described in the specification, and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system, or be part of multiple systems.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (open-ended terminology).

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description of the example implementations should be taken by way of illustration rather than by way of limitation of the subject matter defined by the claims. In addition, the provision of the examples described herein, as well as clauses phrased as “such as,” “including,” and the like, should not be interpreted as limiting the subject matter of the claims to the specific examples; rather, the examples are intended to illustrate one of many possible examples. Further, the same reference numbers in different drawings can identify the same or similar elements.

1. A method for generating curated content comprising:
receiving, by one or more processors, a user query corresponding to a business;
receiving, by the one or more processors, data related to the business and data related to a user associated with the user query; and
generating, by the one or more processors, a curated profile corresponding to the business based on the data related to the business and the data related to the user associated with the query, wherein generating the curated profile includes generating, by a machine learning model, a business description, the business description providing an overview description of the business.

2. The method of claim 1, wherein the user query is received from a service application comprising any one or more of a search engine, mapping application, email application, social application, video application or website, or app store.

3. The method of claim 1, wherein the data related to the business includes one or more of data from a website, social media, or advertisement associated with the business.

4. The method of claim 1, wherein the data related to the user includes one or more of demographics, location, or browsing history associated with the user.

5. The method of claim 1, wherein the curated profile includes information related to the business, the information related to the business including one or more of a logo of the business, a link to a website of the business, or a link to a social media account of the business.

6. The method of claim 1, wherein generating the curated profile includes generating, by the machine learning model, personalized tabs, the personalized tabs corresponding to categories of information about the business, wherein the personalized tabs are identified as being of interest to the user.

7. The method of claim 6, wherein each of the personalized tabs includes respective curated content relevant to the user query and the user data.

8. The method of claim 1, wherein the curated profile further includes personalized content, wherein the personalized content include one or more of links to web content, images, or multimedia that is curated according to the user query and/or user preferences.

9. The method of claim 8, wherein the personalized content is further generated based on information related to the business.

10. The method of claim 1, wherein the curated profile is generated in response to a request received from a service application.

11. A system comprising:
one or more computing devices configured to:
receive a user query corresponding to a business;
receive data related to the business and data related to a user associated with the user query; and
generate a curated profile corresponding to the business based on the data related to the business and the data related to the user associated with the query.

12. The system of claim 11, wherein the user query is received from a service application comprising any one or more of a search engine, mapping application, email application, social application, video application or website, or app store.

13. The system of claim 11, wherein the data related to the business includes one or more of data from a website, social media, or advertisement associated with the business.

14. The system of claim 11, wherein the data related to the user includes one or more of demographics, location, or browsing history associated with the user.

15. The system of claim 11, wherein the curated profile includes information related to the business, the information related to the business including one or more of a logo of the business, a link to a website of the business, or a link to a social media account of the business.

16. The system of claim 11, wherein generating the curated profile includes generating, by the machine learning model, personalized tabs, the personalized tabs corresponding to categories of information about the business, wherein the personalized tabs are identified as being of interest

17. The system of claim 16, wherein each of the personalized tabs includes respective curated content relevant to the user query and the user data.

18. The system of claim 11, wherein the curated profile further includes personalized content, wherein the personalized content include one or more of links to web content, images, or multimedia that is curated according to the user query and/or user preferences.

19. The system of claim 18, wherein the personalized content is further generated based on information related to the business.

20. The system of claim 11, wherein the curated profile is generated in response to a request received from a service application.
